(19) United States
(12) Patent Application Publication
(10) Pub. No.: US 2022/0163968 A1
(43) Pub. Date: May 26, 2022

(54) CONTROL APPARATUS, SYSTEM, VEHICLE, AND SERVICE PROVISION METHOD

(71) Applicant: TOYOTA JIDOSHA KABUSHIKI KAISHA, Toyota-shi Aichi-ken (JP)

(72) Inventors: Akira Sasaki, Miyoshi-shi Aichi-ken (JP); Manabu Ishihara, Nagoya-shi Aichi-ken (JP); Toshiki Kashiwakura, Ota-ku Tokyo-to (JP)

(73) Assignee: TOYOTA JIDOSHA KABUSHIKI KAISHA, Toyota-shi Aichi-ken (JP)

(21) Appl. No.: 17/531,110

(22) Filed: Nov. 19, 2021

(30) Foreign Application Priority Data
Nov. 24, 2020 (JP) 2020-194564

(51) Int. Cl. G05D 1/02; B60R 25/24

(52) U.S. Cl. CPC G05D 1/0212; B60W 60/00256; B60R 25/24

(57) ABSTRACT

A control apparatus includes a controller configured to acquire environment data obtained by observing an environment at a location, and control dispatch of a vehicle loaded with an article for a user who is located at the location, based on the acquired environment data.

### CROSS-REFERENCE TO RELATED APPLICATION

This application claims priority to Japanese Patent Application No. 2020-194564, filed on Nov. 24, 2020, the entire contents of which are incorporated herein by reference.

### TECHNICAL FIELD

The present disclosure relates to a control apparatus, a system, a vehicle, and a service provision method.

### BACKGROUND

Patent Literature (PTL) 1 discloses a server apparatus that acquires information on a product that a user is considering purchasing and information on a desired delivery destination for the product, and gives an operation command to a mobile object, which is loaded with the product and is capable of autonomous traveling, to travel to the desired delivery destination.

### CITATION LIST

### Patent Literature

PTL 1: JP 2019-121086 A

### SUMMARY

It is desirable to provide articles that are appropriate for the environments in which users are located, regardless of whether the users are considering purchasing the articles.

It would be helpful to enable provision of articles that are appropriate for the environments in which users are located.

A control apparatus according to the present disclosure includes a controller configured to:

acquire environment data obtained by observing an environment at a location; and

control dispatch of a vehicle loaded with an article for a user who is located at the location, based on the acquired environment data.

A service provision method according to the present disclosure includes:

acquiring, by a control apparatus, environment data obtained by observing an environment at a location; and

controlling, by the control apparatus, dispatch of a vehicle loaded with an article for a user who is located at the location, based on the acquired environment data.

According to the present disclosure, provision of articles that are appropriate for the environments in which users are located is enabled.

### BRIEF DESCRIPTION OF THE DRAWINGS

In the accompanying drawings:

FIG. 1 is a diagram illustrating a configuration of a system according to a first embodiment of the present disclosure;

FIG. 2 is a block diagram illustrating a configuration of a control apparatus according to the first embodiment of the present disclosure;

FIG. 3 is a flowchart illustrating operations of the system according to the first embodiment of the present disclosure;

FIG. 4 is a flowchart illustrating operations of the control apparatus according to the first embodiment of the present disclosure;

FIG. 5 is a flowchart illustrating operations of the control apparatus according to a variation of the first embodiment of the present disclosure;

FIG. 6 is a flowchart illustrating operations of the system according to a second embodiment of the present disclosure; and

FIG. 7 is a flowchart illustrating operations of the control apparatus according to the second embodiment of the present disclosure.

### DETAILED DESCRIPTION

Hereinafter, some embodiments of the present disclosure will be described with reference to the drawings.

In the drawings, the same or corresponding portions are denoted by the same reference numerals. In the descriptions of the embodiments, detailed descriptions of the same or corresponding portions are omitted or simplified, as appropriate.

A first embodiment, which is an embodiment of the present disclosure, will be described.

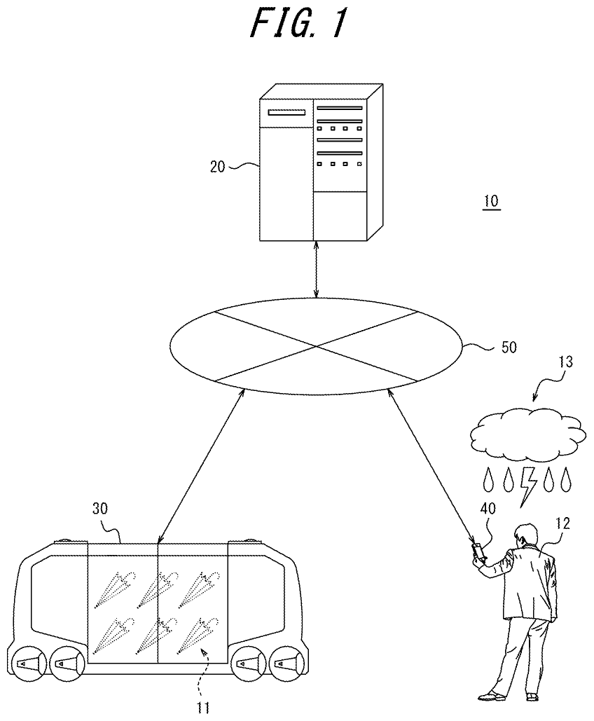

A configuration of a system 10 according to the present embodiment will be described with reference to FIG. 1.

The system 10 according to the present embodiment includes at least one control apparatus 20, at least one vehicle 30, and at least one terminal apparatus 40. The control apparatus 20 can communicate with the vehicle 30 and the terminal apparatus 40 via a network 50. The vehicle 30 may be able to communicate with the terminal apparatus 40 via the network 50.

The control apparatus 20 is installed in a facility such as a data center. The control apparatus 20 is a computer such as a server that belongs to a cloud computing system or another type of computing system.

The vehicle 30 is, for example, any type of automobile such as a gasoline vehicle, a diesel vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The vehicle 30, which is an AV in the present embodiment, may be driven by a driver, or the driving may be automated at any level. The term “AV” is an abbreviation of autonomous vehicle. The automation level is, for example, any one of Level 1 to Level 5 according to the level classification defined by SAE. The name “SAE” is an abbreviation of Society of Automotive Engineers. The vehicle 30 may be a MaaS-dedicated vehicle. The term “MaaS” is an abbreviation of Mobility as a Service.

The terminal apparatus 40 corresponds to a sensor according to the present embodiment. The terminal apparatus 40 is held by a user 12 and used by the user 12. The terminal apparatus 40 is, for example, a mobile device such as a mobile phone, a smartphone, or a tablet.

The network 50 includes the Internet, at least one WAN, at least one MAN, or any combination thereof. The term “WAN” is an abbreviation of wide area network. The term “MAN” is an abbreviation of metropolitan area network. The network 50 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation of local area network.

An outline of the present embodiment will be described with reference to FIG. 1.

The control apparatus 20 acquires first environment data D1 obtained by observing an environment 13 at a location L1. The control apparatus 20 controls dispatch of a vehicle 30 loaded with an article 11 for a user 12 who is located at the location L1, based on the acquired first environment data D1. Therefore, according to the present embodiment, provision of articles 11 that are appropriate for the environments 13 in which users 12 are located is enabled.

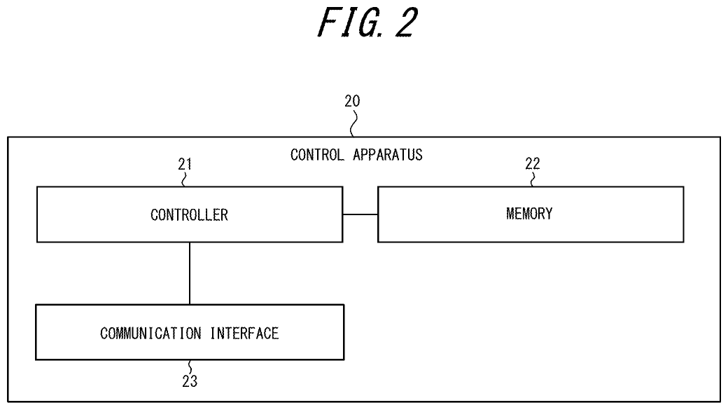

A configuration of the control apparatus 20 according to the present embodiment will be described with reference to FIG. 2.

The control apparatus 20 includes a controller 21, a memory 22, and a communication interface 23.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to operations of the control apparatus 20 while controlling components of the control apparatus 20.

The memory 22 includes at least one semiconductor memory, at least one magnetic memory, at least one optical memory, or any combination thereof. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 22 functions as, for example, a main memory, an auxiliary memory, or a cache memory. The memory 22 stores data to be used for the operations of the control apparatus 20 and data obtained by the operations of the control apparatus 20.

The communication interface 23 includes at least one interface for communication. The interface for communication is, for example, a LAN interface. The communication interface 23 receives data to be used for the operations of the control apparatus 20, and transmits data obtained by the operations of the control apparatus 20.

The functions of the control apparatus 20 are realized by execution of a program according to the present embodiment by a processor serving as the controller 21. That is, the functions of the control apparatus 20 are realized by software. The program causes a computer to execute the operations of the control apparatus 20, thereby causing the computer to function as the control apparatus 20. That is, the computer executes the operations of the control apparatus 20 in accordance with the program to thereby function as the control apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the control apparatus 20 may be realized by a programmable circuit or a dedicated circuit serving as the controller 21. That is, some or all of the functions of the control apparatus 20 may be realized by hardware.

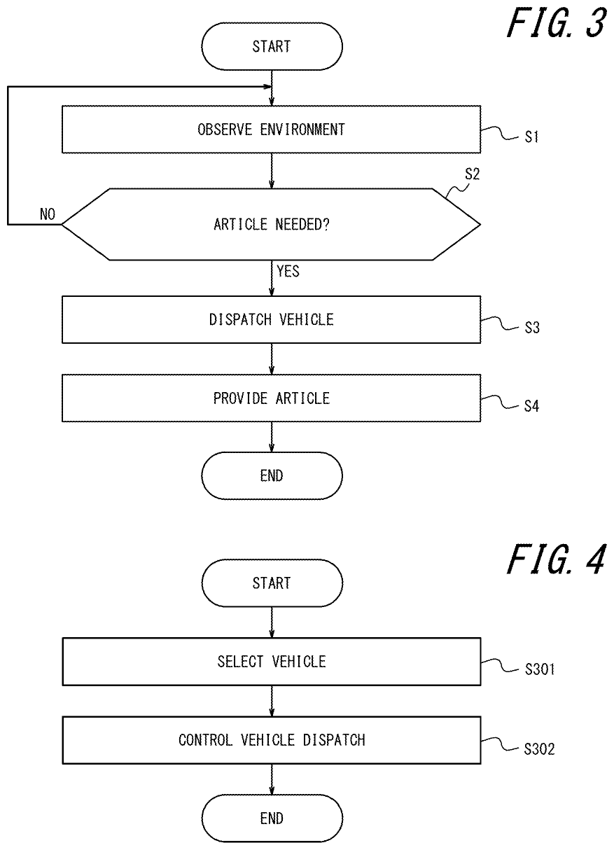

Operations of the system 10 according to the present embodiment will be described with reference to FIG. 3. These operations correspond to a service provision method according to the present embodiment.

In step S1, the terminal apparatus 40 observes an environment 13 at a location L1. The controller 21 of the control apparatus 20 acquires first environment data D1 obtained by observing the environment 13.

Specifically, the terminal apparatus 40 observes precipitation, such as rain, snow, sleet, or hail, at the location L1 using a precipitation sensor mounted on or connected to the terminal apparatus 40. The terminal apparatus 40 transmits data obtained by observing precipitation, such as the amount of precipitation, to the control apparatus 20 as the first environment data D1 via an interface compliant with a mobile communication standard such as LTE, the 4G standard, or the 5G standard. The term “LTE” is an abbreviation of Long Term Evolution. The term “4G” is an abbreviation of 4th generation. The term “5G” is an abbreviation of 5th generation. The communication interface 23 of the control apparatus 20 receives the transmitted first environment data D1 from the terminal apparatus 40. The controller 21 of the control apparatus 20 acquires the first environment data D1 received by the communication interface 23.

Instead of, or along with, the data obtained by observing precipitation, the first environment data D1 may include data obtained by observing a disaster. In such a variation, the terminal apparatus 40 observes a disaster, such as an earthquake or a fire, at the location L1 using a disaster sensor, such as a seismic sensor or an image sensor, mounted on or connected to the terminal apparatus 40. The terminal apparatus 40 transmits data obtained by observing a disaster, such as seismic intensity or the extent of a fire, to the control apparatus 20 as at least a portion of the first environment data D1.

Instead of, or along with, the data obtained by observing precipitation, the first environment data D1 may include data obtained by observing another type of weather. In such a variation, the terminal apparatus 40 observes weather, such as temperature, humidity, wind, or sunshine, at the location L1 using a weather sensor, such as a temperature sensor, a humidity sensor, a wind sensor, or a sunshine sensor, mounted on or connected to the terminal apparatus 40. The terminal apparatus 40 transmits data obtained by observing weather, such as temperature, humidity, wind direction, wind speed, or sunshine duration, to the control apparatus 20 as at least a portion of the first environment data D1.

In step S2, the controller 21 of the control apparatus 20 determines whether an article 11 for a user 12 who is located at the location L1 is needed, based on the first environment data D1 acquired in step S1. In a case in which the article 11 is not needed, the process in step S1 is executed again. In a case in which the article 11 is needed, the process in step S3 is executed.

Specifically, the controller 21 of the control apparatus 20 determines whether an observation value, such as the amount of precipitation, indicated by the first environment data D1 is within an allowable range such that the article 11 is not needed. The article 11 includes an umbrella or rain gear. The allowable range may be set freely and adjusted as appropriate. In a case in which the observation value is within the allowable range, the process in step S1 is executed again. In a case in which the observation value is outside the allowable range, the process in step S3 is executed.

In a case in which the first environment data D1 includes data obtained by observing a disaster, the controller 21 determines whether an observation value, such as seismic intensity or the extent of a fire, indicated by the first environment data D1 is within an allowable range such that the article 11 is not needed. The article 11 includes a first aid kit. The allowable range may be set freely and adjusted as appropriate.

In a case in which the first environment data D1 includes data obtained by observing weather other than precipitation, the controller 21 determines whether an observation value, such as temperature, humidity, wind direction, wind speed, or sunshine duration, indicated by the first environment data D1 is within an allowable range such that the article 11 is not needed. The article 11 includes a beverage or cold weather gear. The allowable range may be set freely and adjusted as appropriate.

It may be determined what type of article is needed as the article 11 for the user 12 based on the first environment data D1. That is, the article 11 for the user 12 may be selected from the first environment data D1. For example, a table or determination logic may be provided in the memory 22, and when the first environment data D1 is input, the table may be referred to or the determination logic may be applied to thereby determine the article 11. Two or more types of articles may each be selected as the article 11. For example, in a case in which the first environment data D1 includes data obtained by observing precipitation and data obtained by observing a disaster, and the respective observation values are outside the allowable range, an umbrella or rain gear and a first aid kit may each be selected as the article 11.

In step S3, the controller 21 of the control apparatus 20 controls dispatch of a vehicle 30 loaded with the article 11. The vehicle 30 delivers the article 11 to the location L1.

Specifically, as illustrated in FIG. 4, in step S301, the controller 21 of the control apparatus 20 selects a vehicle 30 to be dispatched from among a plurality of vehicles loaded with different articles for each vehicle, based on the first environment data D1 acquired in step S1. For example, assuming that a vehicle V1 loaded with umbrellas, a vehicle V2 loaded with first aid kits, and a vehicle V3 loaded with beverages are available for dispatch, and that it is determined in step S2 that an umbrella is needed, the controller 21 selects the vehicle V1 as the vehicle 30 to be dispatched. In step S302, the controller 21 controls the communication interface 23 to transmit first instruction data D2 instructing that the article 11 be delivered to the location L1. The communication interface 23 transmits the first instruction data D2 to the vehicle 30 selected in step S301. The vehicle 30 receives the transmitted first instruction data D2 from the control apparatus 20 via an interface compliant with a mobile communication standard such as LTE, the 4G standard, or the 5G standard. The vehicle 30 delivers the article 11 to the location L1 in accordance with the received first instruction data D2.

The first instruction data D2 may include data specifying the location L1 in any format, but in the present embodiment, the first instruction data D2 includes data specifying the location L1 in coordinates. The coordinates of the location L1 are communicated from the terminal apparatus 40 to the control apparatus 20 in the following procedure.

The terminal apparatus 40 identifies the coordinates of the location L1 by measuring the position of the terminal apparatus 40 using a GNSS receiver. The term “GNSS” is an abbreviation of global navigation satellite system. GNSS is, for example, GPS, QZSS, BDS, GLONASS, or Galileo. The term “GPS” is an abbreviation of Global Positioning System. The term “QZSS” is an abbreviation of Quasi-Zenith Satellite System. QZSS satellites are called quasi-zenith satellites. The term “BDS” is an abbreviation of BeiDou Navigation Satellite System. The term “GLONASS” is an abbreviation of Global Navigation Satellite System. The terminal apparatus 40 transmits coordinate data D3 indicating the identified coordinates to the control apparatus 20 via the interface compliant with the mobile communication standard. The communication interface 23 of the control apparatus 20 receives the transmitted coordinate data D3 from the terminal apparatus 40. The controller 21 of the control apparatus 20 acquires the coordinate data D3 received by the communication interface 23.

The coordinate data D3 may be transmitted from the terminal apparatus 40 to the control apparatus 20 in step S3 or transmitted from the terminal apparatus 40 to the control apparatus 20 prior to step S3. For example, the coordinate data D3 may be included in the first environment data D1 and transmitted in step S1.

In step S4, the vehicle 30 provides the article 11 to the user 12.

Specifically, upon arriving at the location L1, the vehicle 30 presents a message to the user 12 prompting the user 12 to remove the article 11, and opens a door of the vehicle 30 for the user 12 to remove the article 11. For example, the vehicle 30 displays a text message, prompting the user 12 to remove an umbrella, on a display such as an LCD or an organic EL display attached to the vehicle 30, and opens a door of the vehicle 30 for the user 12 to remove the umbrella. The term “LCD” is an abbreviation of liquid crystal display. The term “EL” is an abbreviation of electro luminescence.

Instead of being removed by the user 12, the article 11 may be removed by a crew member of the vehicle 30. In such a variation, upon arriving at the location L1, the vehicle 30 presents a message to the crew member prompting the crew member to hand the article 11 to the user 12, and opens a door of the vehicle 30 for the user 12 to receive the article 11 from the crew member. For example, the vehicle 30 outputs an audio message, prompting the crew member to hand an umbrella to the user 12, from a speaker attached to the vehicle 30, and opens a door of the vehicle 30 for the user 12 to receive the umbrella from the crew member.

As described above, in the present embodiment, the controller 21 of the control apparatus 20 acquires first environment data D1 obtained by observing an environment 13 at the location L1. The controller 21 controls dispatch of a vehicle 30 loaded with an article 11 for a user 12 who is located at the location L1, based on the acquired first environment data D1. Therefore, according to the present embodiment, provision of articles 11 that are appropriate for the environments 13 in which users 12 are located is enabled. That is, in a case in which environmental changes occur, such as worsening weather conditions, necessary articles that suit the environmental changes can be supplied to necessary locations in a timely manner.

In the present embodiment, an article 11 to be provided to the user 12 is indirectly selected by selection of a vehicle 30 to be dispatched, but as a variation of the present embodiment, an article 11 to be provided to the user 12 may be selected directly. In such a variation, the process in step S3 is executed in the following procedure.

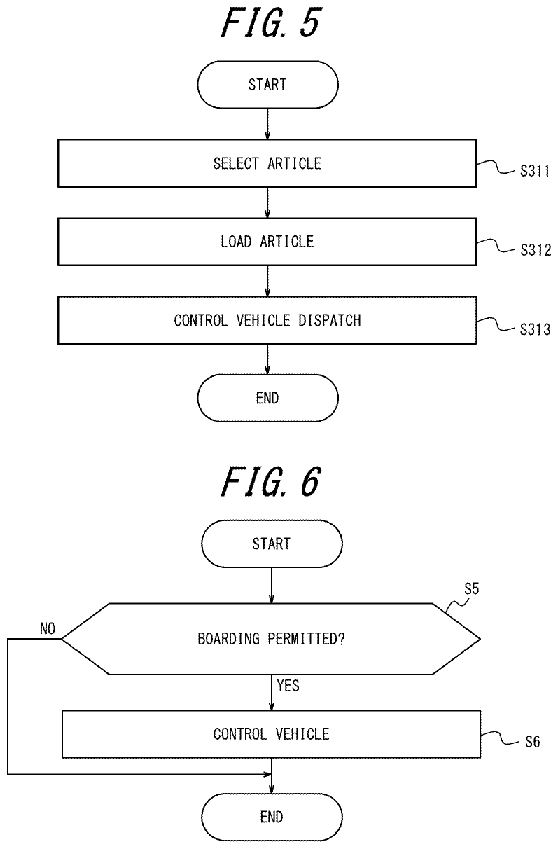

As illustrated in FIG. 5, in step S311, the controller 21 of the control apparatus 20 selects an article 11 to be loaded on a vehicle 30 from among a plurality of articles, based on the first environment data D1 acquired in step S1. For example, assuming that umbrellas, first aid kits, and beverages can be loaded onto the vehicle 30, and that it is determined in step S2 that an umbrella is needed, the controller 21 selects an umbrella as the article 11 to be loaded on the vehicle 30. In step S312, the controller 21 controls the communication interface 23 to transmit second instruction data D4 instructing that the article 11 selected in step S311 be loaded. The communication interface 23 transmits the second instruction data D4 to the vehicle 30. The vehicle 30 receives the transmitted second instruction data D4 from the control apparatus 20 via the interface compliant with the mobile communication standard. The article 11 selected in step S311 is loaded onto the vehicle 30 in accordance with the received second instruction data D4. For example, the vehicle 30 loads an umbrella onto itself using machinery such as a crane or a conveyor provided externally to the vehicle 30 or an arm attached to the vehicle 30. Alternatively, the vehicle 30 outputs an audio message, prompting the crew member of the vehicle 30 to load an umbrella onto the vehicle 30, from a speaker attached to the vehicle 30 to have the crew member load the umbrella. In step S313, the controller 21 controls the communication interface 23 to transmit first instruction data D2 instructing that the article 11 be delivered to the location L1. The communication interface 23 transmits the first instruction data D2 to the vehicle 30. The vehicle 30 receives the transmitted first instruction data D2 from the control apparatus 20 via the interface compliant with the mobile communication standard. The vehicle 30 delivers the article 11 to the location L1 in accordance with the received first instruction data D2.

As a variation of the present embodiment, after step S4, the user 12 may be transported by the vehicle 30 to a location L2 different from the location L1 in a case in which there is sufficient space available in the vehicle 30. A second embodiment, which is such a variation, will be described.

Operations of the system 10 according to the present embodiment will be described with reference to FIG. 6. These operations correspond to a service provision method according to the present embodiment.

In step S5, the vehicle 30 monitors the remaining amount of loaded articles in the vehicle 30. The smaller the remaining amount of loaded articles is, the larger the available space is in the vehicle 30. The controller 21 of the control apparatus 20 determines whether to permit the user 12 to board the vehicle 30 according to the size of the available space in the vehicle 30 after the article 11 is provided to the user 12. In a case in which the user 12 is not permitted to board, the flow of FIG. 6 ends. In a case in which the user 12 is permitted to board, the process in step S6 is executed.

Specifically, the vehicle 30 monitors the remaining amount of loaded articles using an in-vehicle sensor, such as an image sensor or a weight sensor, attached to the vehicle 30. The vehicle 30 transmits data obtained by monitoring the remaining amount of loaded articles, such as an image or the weight of the loaded articles remaining in the vehicle 30, to the control apparatus 20 as remaining amount data D5 via the interface compliant with the mobile communication standard. The communication interface 23 of the control apparatus 20 receives the transmitted remaining amount data D5 from the vehicle 30. The controller 21 of the control apparatus 20 acquires the remaining amount data D5 received by the communication interface 23. The controller 21 determines whether the available space in the vehicle 30 is sufficiently large for the user 12 to board by analyzing an image included in the acquired remaining amount data D5 or by comparing a numerical value, such as weight, indicated by the acquired remaining amount data D5 with a threshold. In a case in which the available space is not large, the flow of FIG. 6 ends. In a case in which the available space is sufficiently large, the process in step S6 is executed.

In step S6, the controller 21 of the control apparatus 20 controls the vehicle 30. The vehicle 30 transports the user 12 to a location L2 different from the location L1.

Specifically, the controller 21 of the control apparatus 20 controls the communication interface 23 to transmit third instruction data D6 instructing that operations be performed according to the result of the determination in step S5. The communication interface 23 transmits the third instruction data D6 to the vehicle 30. The vehicle 30 receives the transmitted third instruction data D6 from the control apparatus 20 via the interface compliant with the mobile communication standard. The vehicle 30 performs the operations as instructed by the received third instruction data D6.

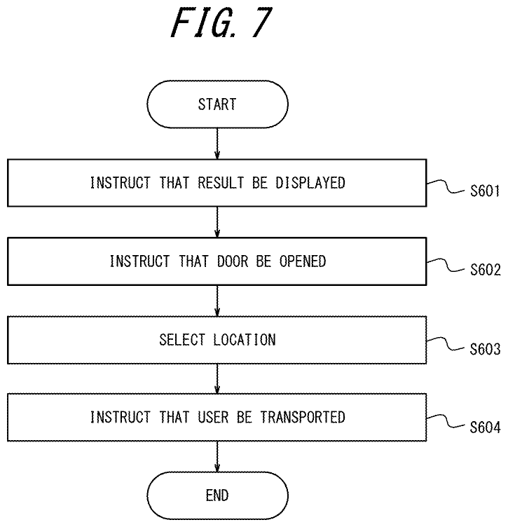

In the present embodiment, as illustrated in FIG. 7, in step S601, the communication interface 23 of the control apparatus 20 transmits, to the vehicle 30 as a portion of the third instruction data D6, data instructing that the result of the determination by the controller 21 be presented to the user 12. In accordance with the transmitted data, the vehicle 30 displays a text message that prompts boarding on a display attached to the vehicle 30. Alternatively, the vehicle 30 outputs an audio message that prompts boarding from a speaker attached to the vehicle 30. In step S602, the communication interface 23 transmits, to the vehicle 30 as another portion of the third instruction data D6, data instructing that a door of the vehicle 30 be opened. In accordance with the transmitted data, the vehicle 30 opens a door of the vehicle 30 for the user 12 to board. In step S603, the controller 21 of the control apparatus 20 acquires second environment data D7 obtained by observing environments, such as precipitation, at a plurality of locations Ls different from the location L1, from sensors that are located at the plurality of locations Ls. The controller 21 selects a location L2 to which the user 12 is to be transported from among the plurality of locations Ls, based on the acquired second environment data D7. For example, as the location L2, the controller 21 selects a location, from among the plurality of locations Ls, whose observation value, such as the amount of precipitation, indicated by the second environment data D7 is within an allowable range such that the article 11 is not needed. Alternatively, as the location L2, the controller 21 selects a location, from among the plurality of locations Ls, whose observation value, such as the amount of precipitation, indicated by the second environment data D7 is closest to an ideal value. In step S604, the communication interface 23 transmits, to the vehicle 30 as yet another portion of the third instruction data D6, data instructing that the user 12 be transported to the location L2. The vehicle 30 transports the user 12 to the location L2 in accordance with the transmitted data.

As described above, in the present embodiment, the controller 21 of the control apparatus 20 determines whether to permit the user 12 to board the vehicle 30 according to the size of the available space in the vehicle 30 after the article 11 is provided to the user 12. Therefore, according to the present embodiment, the available space inside the vehicle 30 can be utilized effectively.

In the present embodiment, the communication interface 23 of the control apparatus 20 transmits, to the vehicle 30, third instruction data D6 instructing that operations be performed according to the result of the determination by the controller 21. The third instruction data D6 includes, in a case in which the user 12 is permitted to board, data instructing that the user 12 be transported to a location L2 different from the location L1. Therefore, according to the present embodiment, the user 12 can be evacuated from the location L1 to a different environment.

As a variation of the present embodiment, the third instruction data D6 may be transmitted from the control apparatus 20 to the vehicle 30 even in a case in which the user 12 is not permitted to board. In such a variation, the communication interface 23 of the control apparatus 20 transmits, to the vehicle 30 as a portion of the third instruction data D6, data instructing that the determination that the user 12 is not permitted to board be presented to the user 12 as the result of the determination by the controller 21. In accordance with the transmitted data, the vehicle 30 displays a text message, notifying that there is no space for boarding, on a display attached to the vehicle 30. Alternatively, the vehicle 30 outputs an audio message, notifying that there is no space for boarding, from a speaker attached to the vehicle 30.

The present disclosure is not limited to the embodiment described above. For example, two or more blocks described in the block diagrams may be integrated, or a block may be divided. Instead of executing two or more steps described in the flowcharts in chronological order in accordance with the description, the steps may be executed in parallel or in a different order according to the processing capability of the apparatus that executes each step, or as required. Other modifications can be made without departing from the spirit of the present disclosure.

For example, the control apparatus 20 may be included in a vehicle 30. In that case, some of the operations of the vehicle 30 may be performed by the control apparatus 20.

For example, instead of the terminal apparatus 40, a sensor installed at the location L1 may observe an environment 13. In that case, the coordinates of the location L1 need not be communicated from the sensor to the control apparatus 20 as long as the position of the sensor is known.

1. A control apparatus comprising a controller configured to:
acquire environment data obtained by observing an environment at a location; and
control dispatch of a vehicle loaded with an article for a user who is located at the location, based on the acquired environment data.

2. The control apparatus of claim 1, wherein the controller is configured to select a vehicle to be dispatched from among a plurality of vehicles loaded with different articles for each vehicle, based on the environment data.

3. The control apparatus of claim 1, wherein the controller is configured to select an article to be loaded on the vehicle from among a plurality of articles, based on the environment data.

4. The control apparatus of claim 1, wherein the environment data includes data obtained by observing precipitation at the location.

5. The control apparatus of claim 4, wherein the article includes an umbrella or rain gear.

6. The control apparatus of claim 1, wherein the environment data includes data obtained by observing a disaster at the location.

7. The control apparatus of claim 6, wherein the article includes a first aid kit.

8. The control apparatus of claim 1, wherein the environment data includes data obtained by observing weather at the location.

9. The control apparatus of claim 8, wherein the article includes a beverage or cold weather gear.

10. The control apparatus of claim 1, wherein the controller is configured to determine whether to permit the user to board the vehicle according to a size of available space in the vehicle after the article is provided to the user.

11. The control apparatus of claim 10, further comprising a communication interface configured to transmit, to the vehicle, instruction data instructing that operations be performed according to a result of determination by the controller.

12. The control apparatus of claim 11, wherein the instruction data includes data instructing that the result of the determination by the controller be presented to the user.

13. The control apparatus of claim 11, wherein the instruction data includes, in a case in which the user is permitted to board, data instructing that a door of the vehicle be opened.

14. The control apparatus of claim 11, wherein the location is a first location, and the instruction data includes, in a case in which the user is permitted to board, data instructing that the user be transported to a second location different from the first location.

15. The control apparatus of claim 14, wherein the location is a first location, and the controller is configured to select a location to which the user is to be transported from among a plurality of second locations different from the first location, based on data obtained by observing environments at the plurality of second locations.

16. A system comprising:
the control apparatus of claim 1; and
the vehicle.

17. The system of claim 16, further comprising a sensor configured to observe an environment at the location.

18. A vehicle comprising the control apparatus of claim 1.

19. A service provision method comprising:
acquiring, by a control apparatus, environment data obtained by observing an environment at a location; and
controlling, by the control apparatus, dispatch of a vehicle loaded with an article for a user who is located at the location, based on the acquired environment data.

20. The service provision method of claim 19, further comprising delivering, by the vehicle, the article to the location.
